(19) United States
(12) Patent Application Publication
(10) Pub. No.: US 2024/0394512 A1
(43) Pub. Date: Nov. 28, 2024

(54) Hallucination Detection

(71) Applicant: Sage Global Services Limited, Newcastle upon Tyne (GB)

(72) Inventors: Ben Cunningham, Warren, NJ (US); David Loving, Moore, OK (US); Jeremiah Edwards, Boulder, CO (US); Jordan Earnest, San Francisco, CA (US); Rohit Kumar, Acton, MA (US); Srijith Rajamohan, Crozet, VA (US); Yu-Cheng Tsai, Redmond, WA (US)

(73) Assignee: Sage Global Services Limited, Newcastle upon Tyne (GB)

(21) Appl. No.: 18/670,313

(22) Filed: May 21, 2024

Related U.S. Application Data
(60) Provisional application No. 63/468,129, filed on May 22, 2023.
(60) Provisional application No. 63/537,272, filed on Sep. 8, 2023.

(51) Int. Cl. G06N 3/0455; G06Q 10/107

(52) U.S. Cl. CPC G06N 3/0455; G06Q 10/107

(57) ABSTRACT

A computer implemented method of detecting hallucination in a large language model (LLM) output. A message is received. A prompt is generated for an LLM including the message and an instruction to generate an output identifying predetermined content in the message. The prompt is passed through an LLM to generate the output. The output is processed in accordance with a hallucination detection process to identify if any predetermined content identified by the LLM in the output is potentially hallucinated.

### CROSS REFERENCE TO RELATED APPLICATIONS

This application claims priority to and the benefit of U.S. Provisional Patent Application No. 63/468,129,filed on May 22, 2023, entitled “GENERATIVE AI”, and U.S. Provisional Patent Application No. 63/537,272, filed on Sep. 8, 2023, and entitled “GENERATIVE AI”, the contents of each of which are incorporated herein by reference as though fully set forth herein.

### TECHNICAL FIELD

The present invention relates to techniques for mitigating hallucination in systems employing generative AI.

### BACKGROUND

The explosive increase in the capability of publicly available generative AI technologies that occurred in late 2022 and early 2023 has led to a rapid and widespread attempt to incorporate such technology in businesses across a range of sectors.

In accounting operations management, which is centred around accounts receivable and accounts payable processes, systems incorporating newly developed AI technologies have the potential to automate many time-consuming tasks which are conventionally performed manually. Such tasks include sorting through digital communications to extract key business data, determining the context with which the data is presented and then performing the required accounting or administrative action.

However, a substantial problem with these new AI systems has emerged in the form of a phenomenon known as ‘hallucination’. Hallucination refers to instances where generative AI systems generate outputs that are disconnected from their inputs, or mistakenly detect or infer (i.e. “hallucinate”) data or general information that doesn't exist.

This phenomenon is a consequence of the probabilistic manner in which these AI models process and generate information. These models, trained on vast amounts of data, learn to make predictions based on patterns they recognize in the training data. However, since these predictions are probabilistic and not deterministic, the models can sometimes generate outputs that appear sensible but are not grounded in the actual input data. This lack of direct input-output mapping can lead to instances of hallucination, where the AI ‘imagines’ or infers data points or trends that do not actually exist.

This issue is further compounded by the inherent unpredictability of when such hallucinations might occur. Because the AI models create hallucinated outputs based on learned patterns rather than specific input data, it is not possible to anticipate or predict when a hallucination will occur.

This issue is particularly problematic when attempting to automate processes that handle business critical data. For example, if there is a possibility that an AI invoice handling system might “hallucinate” an invoice number or invoice amount, then such a system cannot be deployed without manual oversight which would hamper the extent to which it could be scaled. Furthermore, the high plausibility of these hallucinations presents an additional challenge, as these errors can easily pass unnoticed in manual reviews or standard automated checks, leading to potentially serious consequences when used in critical business operations.

Consequently, until the issue of hallucination is addressed, the extensive potential of generative AI technology to automate accounting operations is going to be difficult to realise.

### SUMMARY

In accordance with a first aspect of the invention, there is provided a computer implemented method of detecting hallucination in a large language model (LLM) output. The method comprises the steps of: receiving a message; generating a prompt for an LLM including the message and an instruction to generate an output identifying predetermined content in the message; passing the prompt through an LLM to generate the output; processing the output in accordance with a hallucination detection process to identify if any predetermined content identified by the LLM in the output is potentially hallucinated.

Optionally, the method further comprises generating an output indicative of whether the hallucination detection process has identified that the predetermined content identified in the output is potentially hallucinated.

Optionally, processing the output in accordance with the hallucination detection process comprises: performing a content search operation of the received message to identify in the received message the predetermined content identified in the output of the LLM, and, if the predetermined content identified in the output of the LLM is not identified in the received message, identifying the output of the LLM as potentially hallucinated.

Optionally, processing the output in accordance with the hallucination detection process comprises: receiving from an LLM API confidence score data associated with the output generated by the LLM; determining if a confidence score associated with the confidence score data exceeds a predetermined confidence threshold, and, if the confidence score does not exceed the predetermined threshold, identifying the output of the LLM as potentially hallucinated.

Optionally, the predetermined content comprises predetermined business process metadata.

Optionally, the predetermined business process metadata comprises predetermined financial transaction metadata.

Optionally, the message is an email.

Optionally, generating the prompt for the LLM comprises generating a prompt including unstructured text data from the body and/or header of the email and the instruction to generate the output identifying predetermined content in the text data of the message.

In accordance with a second aspect of the invention, there is provided a computer system for detecting hallucination in a large language model (LLM) output. The system comprises a message receiving module communicatively connected to a prompt generation module. The message receiving module is configured to receive a message and pass the message to the prompt generation module. The prompt generation module is configured to generate a prompt for an LLM including the message and an instruction to generate an output identifying predetermined content in the message. The prompt generation module is configured to communicate the generated prompt to an LLM API and said LMM API configured to pass the prompt through an LLM to generate the output. The system further comprises a hallucination detection module, said hallucination detection module configured to receive the output of the LLM from the LLM API and process the output in accordance with a hallucination detection process to identify if any predetermined content identified by the LLM in the output is potentially hallucinated.

Optionally, the hallucination detection module is further configured to generate an output indicative of whether the hallucination detection process has identified that the predetermined content identified in the output is potentially hallucinated.

Optionally, the hallucination detection module is configured to perform the hallucination detection process by performing a content search operation of the received message to identify in the received message the predetermined content identified in the output of the LLM. If the predetermined content identified in the output of the LLM is not identified in the received message, the hallucination detection module is configured to identify the output of the LLM as potentially hallucinated.

Optionally, the hallucination detection module is configured to perform the hallucination detection process by: receiving from the LLM API confidence score data associated with the output generated by the LLM; determining if a confidence score associated with the confidence score data exceeds a predetermined confidence threshold, and, if the confidence score does not exceed the predetermined threshold, identifying the output of the LLM as potentially hallucinated.

Optionally, the predetermined content comprises predetermined business process metadata.

Optionally, the predetermined business process metadata comprises predetermined financial transaction metadata.

Optionally, the message is an email.

Optionally, the prompt generation module is configured to generate the prompt for the LLM by generating a prompt including: unstructured text data from the body and/or header of the email, and the instruction to generate the output identifying predetermined content in the text data of the message. In accordance with a further aspect of the invention, there is provided a computer implemented method of detecting hallucination in output of a generative AI system. The method comprises the steps of:
a) receiving user input specifying a query or task relating to information contained in a data object;
b) receiving the data object;
c) generating a first vector representation of the user input and a second vector representation of the data object;
d) comparing the first and second vector representations to identify one or more parts of the data object which most closely match the query or task specified in the user input;
e) generating an input for a generative AI system comprising the user input and the identified one or more parts of the data object;
f) inputting the input to a generative AI system;
g) analysing an output produced by the generative AI system to determine if the output contains information also present in the data object, and if not:
h) initiating an error process, and if so:
i) outputting the output produced by the generative AI system.

Optionally, the error process comprises at least one of regenerating the input for the generative AI system, and outputting an error message.

Optionally, the generative AI system comprise a Large Language Model (LLM).

Optionally, the input for the generative AI system comprises a prompt to use the identified part or parts of the data object to answer the user query or perform the specified task.

Optionally, the method further comprises receiving the user input and the data object via a user interface.

Optionally, the method further comprises outputting the output via the user interface.

Optionally, the method further comprises: generating a further input for the generative AI system comprising the output and an instruction to generate a corresponding database update instruction based on the output; inputting the further input to the generative AI system; inputting a further output from the generative AI system comprising a corresponding database update instruction to a database, and updating the database in accordance with the database update instruction.

Optionally, the method further comprises generating the further input such that it further comprises database schema data associated with the database and the instruction further specifies that the database update instruction should also be based on the database schema data.

In accordance with a further aspect of the invention, there is provided a system for detecting hallucination in output of a generative AI system. The system comprises: a user data processing module configured to receive user input specifying a query or task relating to information contained in a data object and receive the data object; a vector generation module configured to generate a first vector representation of the user input and a second vector representation of the data object; a vector comparison module configured to compare the first and second vector representations to identify one or more parts of the data object which most closely match the query or task specified in the user input; an input generation module configured to generate an input for a generative AI system comprising the user input and the identified one or more parts of the data object, and communicate the input to an AI module, said AI module providing access to a generative AI system and configured to pass the input to the generative AI system to produce an output; and an output review module configured to analyse the output produced by the generative AI system to determine if the output contains information also present in the data object. The output review module is further configured such that: if the output does not contain information also present in the data object, to initiate an error process, and if the output contains information also present in the data object, to output the output produced by the generative AI system.

Optionally, the error process comprises at least one of: controlling the input generation module to regenerate the input for the generative AI system and pass the regenerated input to the AI module, and controlling the input generation module to output an error message.

Optionally, the generative AI system comprise a Large Language Model (LLM).

Optionally, the input for the generative AI system comprises a prompt to use the identified part or parts of the data object to answer the user query or perform the specified task.

Optionally, the user data processing module is configured to receive the user input and the data object via a user interface.

Optionally, the system further comprises a database update module. If the output contains information also present in the data object, the output review module is configured to output the output produced by the generative AI system to the database update module, responsive to which, the database update module is configured to: generate a further input for the generative AI system comprising the output produced by the generative AI system and an instruction to generate a corresponding database update instruction based on the output; input the further input to the generative AI system, and input a further output from the generative AI system comprising a corresponding database update instruction to a database to update the database in accordance with the database update instruction.

Optionally, the database module is further configured to generate the further input such that it further comprises database schema data associated with the database and the instruction further specifies that the database update instruction should also be based on the database schema data.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram depicting functional components of a system for implementing a technique for validating the output of a large language model (LLM);

FIG. 2 provides a diagram depicting a process flow performed by the system shown in FIG. 1;

FIG. 3 provides a simplified schematic diagram depicting an example implementation of the system shown in FIG. 1;

FIG. 4 provides a simplified schematic diagram depicting the functional components of a further system configured to mitigate the effect of hallucination in systems incorporating generative AI such as systems incorporating LLMs;

FIG. 5 provides a diagram depicting a process flow performed by the system shown in FIG. 4;

FIG. 6 provides a representation of a data object, specifically an invoice which can be used in conjunction with the system depicted in FIG. 4;

FIGS. 7 and 8 provide a diagram depicting a display on a user interface 701a in accordance with an example of the technique;

FIG. 9 provides a simplified schematic diagram depicting an example implementation of the system shown in FIG. 4,

FIG. 10 provides a simplified schematic diagram depicting the functional components of a yet further system configured to mitigate the effect of hallucination in systems incorporating generative AI such as systems incorporating LLMs, and

FIG. 11 provides a diagram depicting a process flow performed by the system shown in FIG. 10.

### DETAILED DESCRIPTION

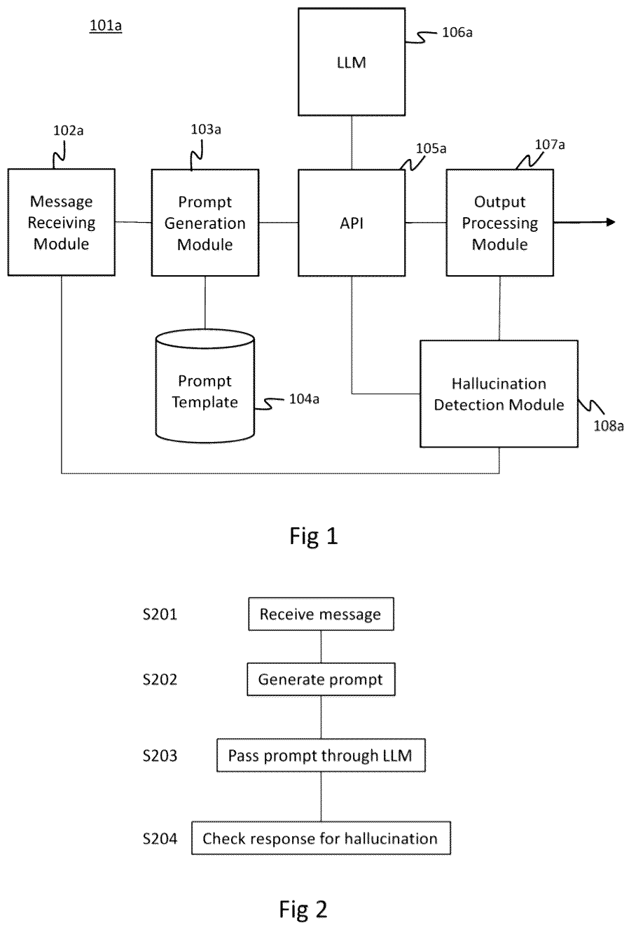

FIG. 1 provides a simplified schematic diagram depicting functional components of a system 101a for implementing a technique for validating the output of a large language model (LLM). Specifically, the technique is for situations where an LLM has been instructed to identify specific “predetermined” content in a message, such as a situation where an LLM has been instructed to identify all invoice numbers present in a received email. The system is configured to determine whether the output of the LLM (e.g. one or more invoice numbers) has been hallucinated.

Examples of this technique find particular utility in identifying predetermined content from received messages that concerns business process metadata, such as scheduling deadlines, tracking project milestones, managing customer interactions, and overseeing inventory levels, and more particularly still in identifying financial transaction metadata such as customer names, supplier names, invoice numbers, purchase order numbers, and payment dates.

FIG. 2 provides a diagram depicting a process flow in accordance with the present technique.

Message receiving module 102a, prompt generation module 103a, prompt template database 104a, LLM API 105a, LLM output processing module 107a, hallucination detection module 108a.

The system 101a comprises a message receiving module 102a communicatively connected to a prompt generation module 103a. The prompt generation module 103a is connected to a prompt template database 104a and an LLM API 105a providing an interface to an LLM 106. The LLM API 105a is further connected to an LLM output processing module 107a. The system 101a further comprises a hallucination detection module 108a which is connected to the LLM output processing module 107a and is also connected to the message receiving module 102a and the LLM API 105a.

In use, the message receiving module 102a is configured to receive a message such as an e-mail for content analysis, for example to identify all the invoice numbers referenced in the e-mail (step S201). On the receipt of such a message, the message receiving module 102a is configured to forward text extracted from the e-mail, for example unstructured text including the subject header and/or body of the e-mail, to the prompt generation module 103a.

The prompt generation module 103a is configured to generate an LLM prompt using a suitable prompt template extracted from the prompt template database 104a to pass to the LLM API 105a (step S202). For example, if the system 101a is configured to identify invoice numbers from an e-mail text, the prompt text retrieved from the prompt template database 104a may comprise prompt text such as “identify invoice numbers in the following text and output text listing those invoice numbers and nothing else <EMAIL TEXT>.”

Using this prompt text, and text from the email received by the message receiving module 102a, the prompt generation module 103a generates a suitable prompt which is passed to the LLM API 105a. The LLM API 105a then forwards this prompt to the LLM 106a which generates output text which is then passed via the LLM API 105a to the LLM output processing module 107a (step S203). The LLM output processing module 107a passes the output text to the hallucination detection module 108a which is configured to perform a hallucination detection process on the output text (S204). For example, if the output text comprises a number of identified invoice number, the hallucination detection module 108a is configured to detect whether any of these invoice numbers have been hallucinated by the LLM 106a.

Typically, the LLM output processing module 107a is configured to generate an output indicative of whether the hallucination detection process has identified that the predetermined content identified in the output is potentially hallucinated.

If no hallucination has been detected by the hallucination detection module 108a, a “no hallucination detected” message is communicated from the hallucination detection module 108a to the LLM output processing module 107a which is then configured to output the detected content, for example the detected invoice numbers.

On the other hand, if the hallucination detection module 108a detects hallucination has occurred, then a “hallucination detected” message is communicated from the hallucination detection module 108a to the LLM output processing module 107a which can then take appropriate action. For example, the detected invoice numbers can be output by the LLM output processing module 107a but with a warning flag indicated that they might be hallucinated. Alternatively, for example, the LLM output processing module 107a may output data indicating that no verified content of the specific type has been identified, e.g., no verified invoice numbers have been detected from the input message.

The hallucination detection module 108a can use any suitable technique for implementing the hallucination detection process.

In one example the hallucination detection process comprises performing a content search operation of the received message. Specifically, the received message is searched to identify if it contains the predetermined content identified in the output of the LLM. If the predetermined content identified in the output of the LLM is not identified in the received message, the output of the LLM can then be classified as potentially hallucinated. In one such example, a rule-based technique can be used whereby the hallucination detection module 108a performs a searching function taking as an input the content identified by the LLM 106a as being present, and then performs a content search, for example text search of the message received by the message receiving module 102a to confirm whether or not the content is actually present in the received message. This can be achieved via the connection between the hallucination detection module 108a and the message receiving module 102a.

Alternatively, the hallucination detection module 108a can receive via the LLM API 105a confidence data generated by the LLM 106a indicative of the confidence associated with the output text of the LLM 106a. If this confidence data is indicative of the output text being generated with a confidence level below a predetermined threshold, for example, the hallucination detection module 108a can be configured to classify the output text generated by the LLM 106a as potentially hallucinated. This confidence data specifically reflects the confidence in the correctness of individual tokens or sequences of tokens within the generated text. Common or expected sequences may receive higher confidence scores, while more unusual or obscure sequences may be assigned lower scores. In this manner, the confidence data serves as a nuanced measure of the reliability of the generated text, enabling more refined detection of potential hallucinations or errors.

The skilled person will understand that the system depicted in FIG. 1 can be implemented in any suitable way. For example, the modules, including the message receiving module 102a, prompt generation module 103a, prompt template database 104a, LLM API 105a, LLM output processing module 107a, and hallucination detection module 108a, might typically be implemented in a single application running on a server. As the skilled person will understand, the server-side application could be hosted in various environments, such as traditional on-premises servers, cloud computing platforms, or serverless computing environments. Different architectures and technologies can be used, depending on the specific needs and preferences of the implementation.

This server-side application, for example, could provide a service to a web application running on a user device. For example, the service provided by the server-side application might be a content recognition service, which could be part of a larger application such as an accounts receivable or accounts processing application which the user accesses via the web application.

In such an example, the web application could be run via a web browser on the user's device and include an interface that allows the user to send a message for analysis to the system 101a, and receive an output generated by the system, specifically by the LLM output processing module 107a.

The server-side application could be implemented in various ways on different suitable environments.

Additionally, module the LLM 106a might be running locally or might be running remotely, for example, handled by a third party.

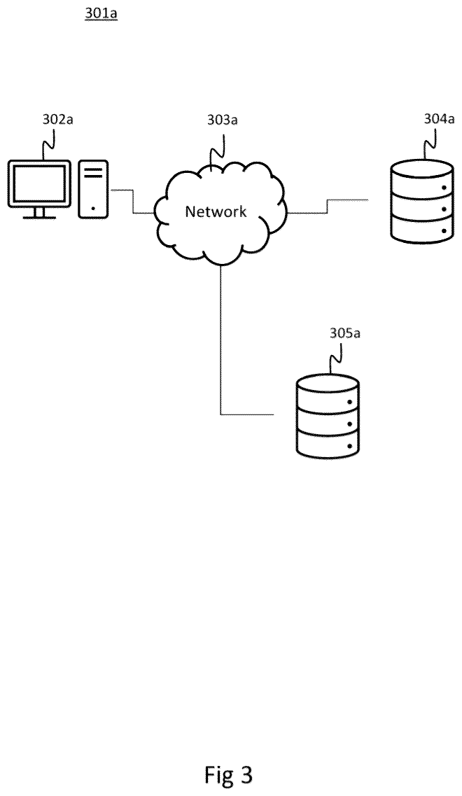

FIG. 3 provides a simplified schematic diagram of an example of an implementation 301a of the system depicted in FIG. 1. FIG. 3 shows a user device 302a connected via a network 303a to a first application server 304a. The first application server 304a has running thereon an application providing the functionality associated with the message receiving module 102a, prompt generation module 103a, prompt template database 104a, LLM API 105a, LLM output processing module 107a and hallucination detection module 108a described above.

FIG. 3 also shows a second application server 305a, corresponding to LLM 106a, connected to the first application server 304a via the network 303a.

The user device 302a, provided by any suitable computing device such as a desktop computer, laptop, tablet, or smartphone, has running thereon a web browser providing a client application via which the user can interact with the application running on the first application server 304a. Specifically, the user device 302a can pass query data to the first application server 304a comprising messages to be analysed for predetermined content, and response data can be generated (e.g. data containing identified predetermined content along with an indication of whether or not the data is potentially hallucinated). Prompts are passed from the application running on the first application server 304a to the LLM running on the second application server 305a which then returns the generated output to the first application server 304a.

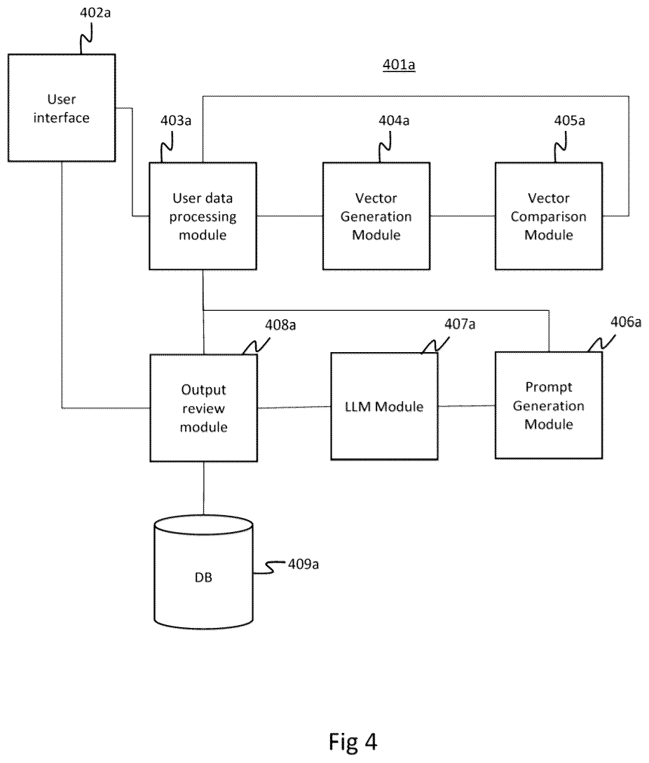

FIG. 4 provides a simplified schematic diagram depicting the functional components of a further system 401a configured to mitigate the effect of hallucination in systems incorporating generative AI such as systems incorporating LLMs.

The system depicted in FIG. 4 is configured to receive user input in the form of user tasks or queries related to information contained in a data object such as an invoice data file or a spreadsheet data file. The system is then configured to use an LLM to generate an output which provides an answer to the query or that allows the task to be completed. However, this is undertaken in such a way that hallucination is reduced or eliminated from the answer to the query or from the completion of the task.

The system 401a comprises a user interface 402a connected to a user data processing module 403a. The user data processing module 403a is connected to a vector generation module 404a which in turn is connected to a vector comparison module 405a. The vector comparison module 405a is also connected to the user data processing module 403a.

The user data processing module 403a is further connected to an input generating module for generating an input for the LLM module 407a, specifically a prompt generation module 406a. The prompt generation module 406a is connected to an LLM module 407a. The LLM module 407a is connected to an output review module 408a. The output review module 408a is connected to the user interface 402a, the user data processing module 403a and a database 409a.

The LLM module 407a can be implemented in any suitable way. For example, it could comprise a system on which an actual LLM is run or provide a means to interface with an external LLM. Such an interface could be achieved through the use of Application Programming Interfaces (APIs) or other standard communication protocols, enabling the LLM module 407a to send LLM queries and receive LLM responses from a remotely run LLM, provided, for example, by a third party.

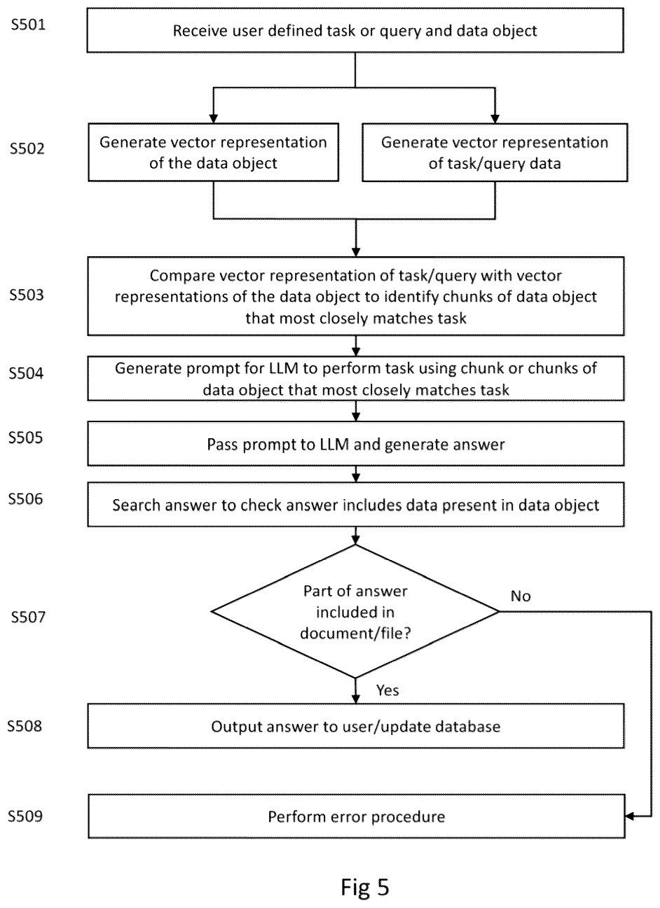

Operation of the system 401a is described with reference to the flow chart depicted in FIG. 5.

At a first step S501, a user provides user input specifying a query or task relating to information contained in a data object via the user interface 402a. The user also identifies the data object to which the user defined query or task relates (e.g. a spreadsheet file such as a .xls file or a document file such as a .pdf file).

The user interface 402a retrieves the data object and passes it, along with task/query data associated with the user-defined task or query to the user data processing module 403a. The task/query data is typically in the form of unstructured text data.

The user data processing module 403a extracts raw data from the data object in a suitable format, and divides this raw data into ‘chunks’, each chunk being, for example, every 100 characters or a paragraph.

This extraction and chunking process can be performed using any suitable technique. For example, if the data object is a spreadsheet file such as a. xls file, the module might use a library like Apache POI to read the cells and rows, and convert them into chunks of a format suitable for vector representation, e.g. raw text data. If the data object is a document file such as a. pdf file, tools like PDFMiner could be used to extract and chunk suitable text data. Typically, the task/query data is provided in a text format, making further conversion unnecessary for vector representation. However, if the task/query data is received in a format not suitable for vector conversion, the user data processing module 403a performs the necessary adjustments to convert it into an appropriate format using a suitable technique.

The chunked raw data extracted from the data object, usually in text format, is then passed from the user data processing module 403a to the vector generation module 404a, along with the task/query data (converted to a suitable format if needed).

At a second step S502, the vector generation module 404a is configured to generate a vector representation of each chunk of the raw data from the data object, and a vector representation of the task/query data (i.e. the user input). This is performed by applying a vector generation algorithm to the chunked raw data and to the task/query data. In a typical example, the chunks of the raw data, and the task/query data are tokenized and converted into vector embeddings using algorithms like TF-IDF or Word2Vec. This produces a vector embedding of the task/query data and a plurality of vector embeddings, each corresponding to a different chunk of the data object.

As will be understood, at this second step S502, the aim of converting the chunked raw data and the task/query data into vector embeddings is to capture their semantic similarities and nuances. Algorithms like TF-IDF or Word2Vec are used to generate vector representations in such a way that semantically similar text data will have vectors that are closer in the vector space.

The plurality of vector embeddings corresponding to the different chunks of the data object, and the vector embedding corresponding to the task/query data are then passed to the vector comparison module 405a.

The vector comparison module 405a is configured to determine which part or parts of the data object most closely match the user task/query by comparing the plurality of vector embeddings corresponding to the different chunks of the data object with the vector embedding corresponding to the task/query data.

Specifically, at a third step S503, the vector comparison module 405a is configured to perform a comparison algorithm to compare and rank each of the chunk vector embeddings against the task/query vector embedding. Techniques such as cosine similarity, Manhattan distance, or other suitable methods can be used to measure how closely each chunk relates to the user's task or query. The module identifies the most relevant chunk or chunks based on this comparison.

The vector comparison module 405a passes data identifying the chunk or chunks that are most relevant to the task/query data to the user data processing module 403a. The user data processing module 403a then locates the part or parts of the raw text data associated with these specific chunks in the data object and passes them to the prompt generation module 406a, along with the original task/query data provided as user input.

At a fourth step S504, the prompt generation module 406a generates an input for the LLM module, specifically a prompt comprising an instruction for the LLM module 407a to use the identified part or parts of the data object to answer the user query or perform the specified task. At a fifth step S505, the prompt thus generated is passed to the LLM module 407a.

The LLM module 407a generates an output which is then passed to the output review module 408a.

At a seventh step S507, the output review module 408a undertakes an output review process. During this process, the output review module 408a retrieves the data object from the user data processing module 403a (using the extracted raw data if appropriate) and compares it to the output from output generated by the LLM module 407a to determine whether or not the output also contains information also present in the data object.

The output review process can use any suitable technique to achieve this, for example, employing regular expressions (regex) to search for specific patterns or sequences within the output of the LLM module 407a that match the information contained within the data object.

If the output does contain at least some part or parts of the original data object, this is indicative of the answer generated by the LLM module 407a being free from any hallucinated output. On the other hand, if the output does not contain any part of the original data object, this is indicative of the answer generated by the LLM module 407a potentially containing hallucinated output.

At an eighth step S508, if the result of the output review process performed at the seventh step S507 is that the output does contain at least some part of the original data object indicating the output is hallucination free, it is output by the system.

For example, if the output from the LLM module 407a is an answer to the user query, this output is then forwarded to the user interface 402a. If the output from the LLM module 407a is a database instruction to undertake a task, as well as being passed to the user interface 402a, the output may also be passed, as an instruction, to the database 409a.

If the result of the output review process performed at the seventh step S507 is that the output does not contain any of the original data object, this indicates that the output may contain hallucinated data. In this case, the process proceeds to a ninth step S509 in which an error process is initiated. This error process can involve communicating an error message for display at the user interface 402a and/or returning to the fourth S504 step to rerun the prompt generation and pass the regenerated prompt through the LLM module 407a to produce another output. In certain examples, the output review module 408a is configured to generate feedback data which can be dynamically appended or prepended to the new prompt. For instance, the new prompt could include a message like ‘previously, invoice number 123 was mistakenly extracted,’ which reduces the chance of a similar mistake occurring.

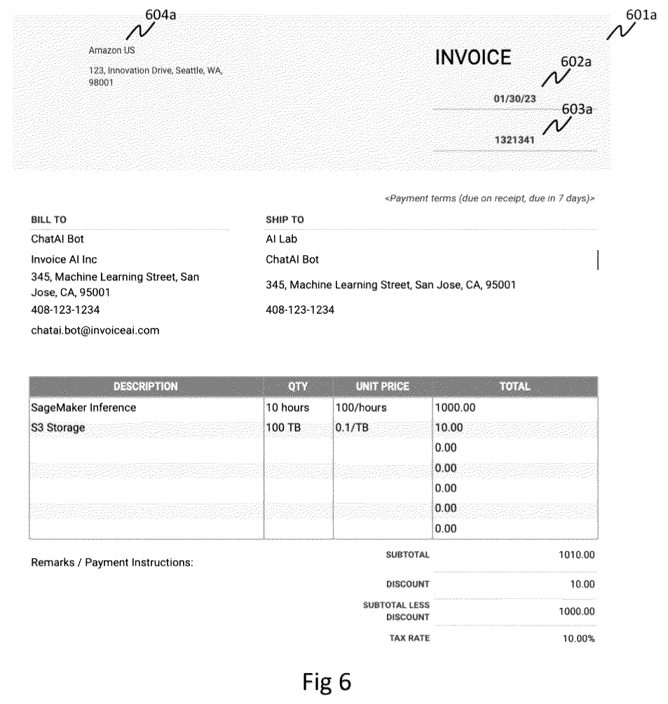

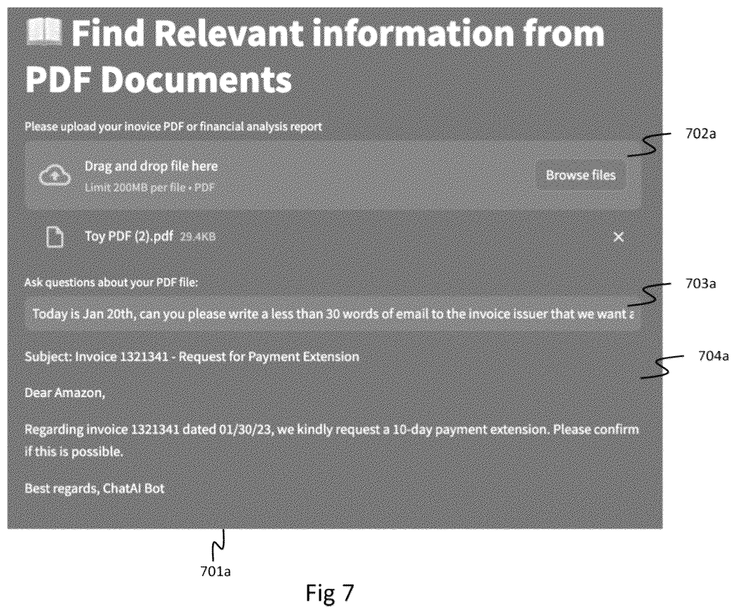

An example of the operation of the system depicted in FIG. 4 is described in further detail with reference to FIGS. 6 and 7.

FIG. 6 provides a representation of a data object which in this example is an invoice 601a. FIG. 7 provides a diagram depicting a display on a user interface 701a in accordance with an example of the technique.

The interface 701a comprises a first area 702a where a user can select data objects from their computing device for passing to the system. The interface 701a comprises a second area 703a where user can input text data providing a user defined query or task. The interface 701a comprises a third area 704a showing the output provided by the system.

In this example, a user inputs text into the second area 703a specifying the following task:
“today is January 20th, can you please write a less than 30 words of e-mail to the invoice issuer that we want a 10 day extension”.

The user identifies a file corresponding to the invoice 601a in the first area 702a.

Text data corresponding to the user task specified in the second area 703a and an invoice file corresponding to the invoice 601a are communicated from the user interface 402a to the user data processing module 403a. The user data processing module 403a extracts raw text data from the invoice files and divides this data into chunks.

The user task text data and the invoice file text chunks are then passed to the vector generation module 404a which generates a vector embedding of the task and a plurality of vector embeddings associated with each chunk of the invoice 601a.

The user task vector embedding, and the chunk vector embeddings are then passed to the vector comparison module 405a which performs a comparison algorithm as described above.

Referring back to FIG. 6, it can be seen that the text data of the invoice 601a includes date data 602a, invoice number data 603a, and invoice issuer data 604a. Because the vector generation algorithm running on the vector generation module 404a generates vector embeddings based on the semantic meaning of these chunks, the vector comparison module 405a will identify the chunks of the text data of the invoice 601a that most closely correspond semantically with the text data of the user-defined task.

In this case, due to their similarity with the semantic context of the user-defined task (i.e. to request an extension to the payment deadline of an invoice), the vector comparison module 405a would be expected to identify the chunks of the text data of the invoice 601a relevant to handling a request to extend the payment deadline associated with a specific invoice. Specifically, it will likely identify parts of text data of the invoice 601a corresponding to the date data 602a, invoice number data 603a, and invoice issuer data 604a.

The vector comparison module 405a outputs data identifying these parts of the invoice 601a to the user data processing module 403a which then passes these identified parts of the raw text of the invoice 601a (e.g. a first chunk including the chunk of data including the invoice date “Jan. 30, 2023”, a second chunk of data including the invoice number “1321341” and a third chunk of data including the invoice sender “Amazon US”) to the prompt generation module 406a along with the text data specifying the user defined task.

The prompt generation module 406a generates a corresponding prompt for LLM module 407a, for example a prompt specifying:
“please complete the following user task: <today is Jan. 20. 2023, can you please write a less than 30 words e-mail to the invoice issuer that we want a 10 day extension using the following data extracted from a relevant data object: <text from first, second and third chunks>”

Where “<text from first, second and third chunks>” is the parts of the raw text of the invoice 601a received from the user data processing module 403a.

In this example, the LLM module 407a would be expected to generate an output similar to the following:
“Subject: Invoice 1321 341-request for payment extension
Dear Amazon,
Regarding invoice 1321341 dated Jan. 30, 2023, we kindly request a 10 day payment extension. Please confirm if this is possible.
Best Regards, ChatAI Bot”

This output is passed to the output review module 408a which compares it to the content of the original data object. In this example, the comparison algorithm running on the output review module 408a will compare the text of the output from the LLM module 407a with the raw text data extracted from the invoice 601a.

As will be understood, the two references to the invoice number “invoice 1321341” in the output from the LLM module 407a will match with the invoice number data 603a of the invoice 601a; the reference to the date “Jan. 30, 2023” will match with the date data 602a of the invoice 601a, and the reference to “Amazon” in the output will match with the invoice issuer data 604a of the invoice 601a.

Accordingly, the output review module 408a will determine that it is likely that the output from the LLM module 407a does not contain hallucinated data, therefore the output of the LLM module 407a will be passed back to the further system 401a. As can be seen from FIG. 7, this output is then displayed in the third area 704a of the interface 701a.

As mentioned above, and certain examples the user defined task may comprise an instruction to update the database 409a.

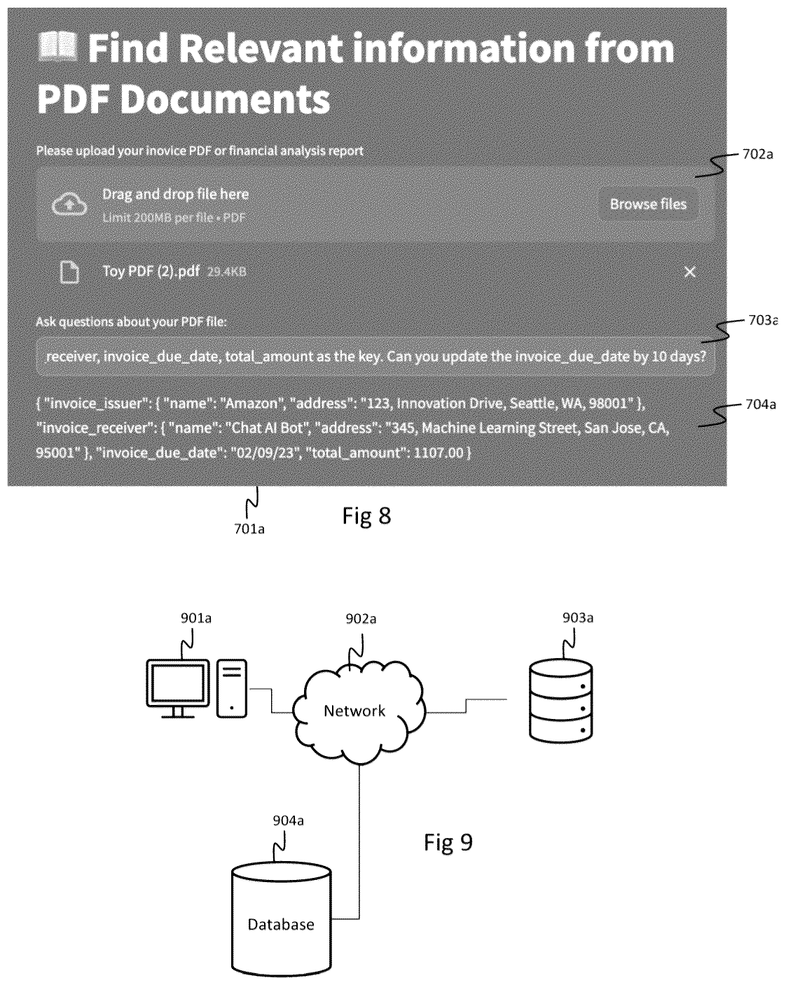

FIG. 8 provides a diagram depicting a display on the user interface 701a in accordance with an example of the invention.

In this example, a user inputs text into the second area 703a specifying the following task:
“for database table XYZ, using “invoice_issuer”, invoice_receiver, invoice_due_date, total_amount as the key. Can you update the invoice_due_date by 10 days? “.

The user identifies a file corresponding to the invoice 601a in the first area 702a. The process described with reference to FIG. 5 is performed and accordingly, an answer is generated comprising an instruction to update a corresponding table in the database 409a to specify that the field “invoice_due_data” is now “Feb. 9, 2023”. This instruction can then be passed from the output review module 408a to the database 409a for executing the instruction.

In certain examples, the generation of an instruction to update the database 409a can be automated. This may be particularly advantageous in settings where the user query or user task will normally necessitate a database update.

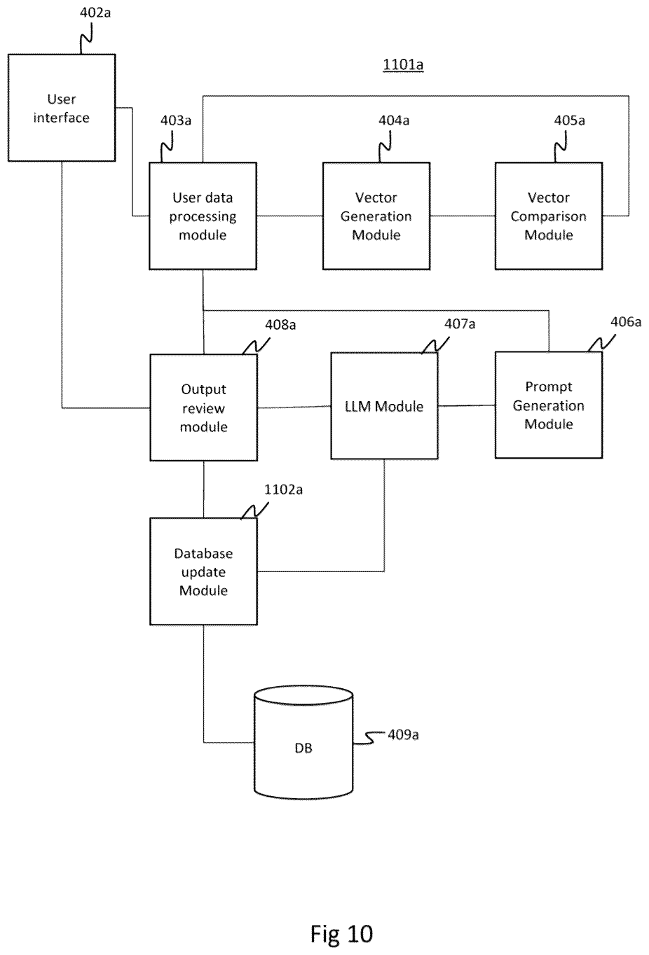

FIG. 10 provides a simplified schematic diagram of a system 1101a in which this database update automation can be implemented. The system 1101a corresponds to the system 401a described with reference to FIG. 4 except that the system 1101a further comprises a database update module 1102a which is connected to the database 409a, the LLM module 407a and the output review module 408a.

The system 1101a operates in substantially the same way as the system depicted in FIG. 4 and described with reference to FIG. 5 to generate an output. However, once the output review module 408a has undertaken the output review process and determined that the output generated by the LLM module 407a contains information present in the data object (indicative of the output generated by the LLM module 407a being free from any hallucinated output), then at a first step S1101, the output is passed from the output review module 408a to the database update module 1102a.

At a second step S1102, the database update module 1102a generates a prompt for the LLM module which includes the output received at the first step S1101, and an instruction to generate a database update instruction based on the output.

In certain examples, to improve the accuracy of the database instruction that is generated, the prompt can also include database schema data, specifying the schema of the database 409a. This schema data can be stored and maintained by the database update module 1102a.

In one example, the database instruction generation prompt generated by the database update module 1102a takes the following form:

“Your task is to generate an instruction for updating a SQL database. The database expects the following schema, {schema of the database}. Please generate the SQL code based on the schema and the following output {output}.

Where, {schema of the database} is where the database schema data would be provided, and {output} is where the output from the LLM module 407a generated at the fifth step S505 and verified by the output review module 408a at the seventh step S507 described above would be provided.

The prompt, thus generated, is then passed to the LLM module 407a to generate a further output, specifically a database update instruction.

At a third step S1103, the prompt is passed through the LLM module 407a and a corresponding database update instruction is generated.

Typically, the database update instruction generated by the LLM module 407a can be passed through the output review module 408a to check for hallucination. If the output is deemed to be hallucination free, then the database update instruction is then passed to the database update module 1102a.

At a fourth step S1104, the database update instruction is passed to the database 409a and the database 409a is updated accordingly.

In a simple illustrative example, if, as described above, via the user interface 701a, a user provides a user query:
“today is January 20th, can you please write a less than 30 words of e-mail to the invoice issuer that we want a10 day extension”,

and provides reference to an invoice file corresponding to the invoice 601a, the LLM module 407a might be expected to produce an output similar to the following:

“Subject: Invoice 1321 341-request for payment extension
Dear Amazon,
Regarding invoice 1321341 dated Jan. 30, 2023, we kindly request a 10 day payment extension. Please confirm if this is possible.
Best Regards, ChatAI Bot”

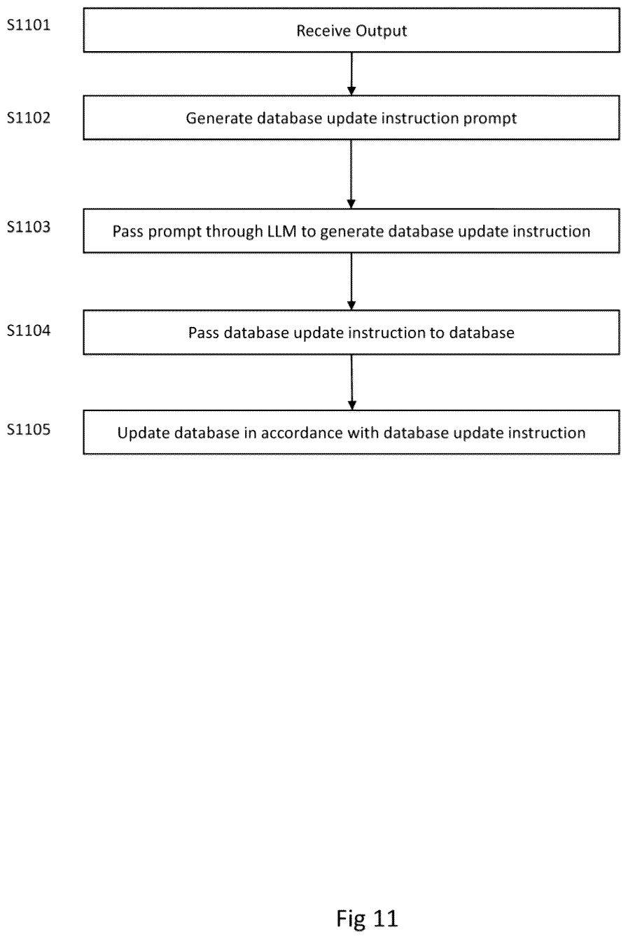

In accordance with the process depicted in FIG. 11, once the output review process has been performed by the output review module 408a and it has been determined that the output does not contain hallucinated content, at the first step S1101, this output is then passed from the output review module 408a to the database update module 1102a.

In this example, the database update module 1102a could then generate a prompt in the following form:
“Your task is to generate an instruction for updating a SQL database. The database expects the following schema: “invoice_issuer”, “invoice_due_date”, “invoice_number”.
Please generate SQL code using the schema and based on the following output:
“Subject: Invoice 1321 341-request for payment extension
Dear Amazon,
Regarding invoice 1321341 dated Jan. 30, 2023, we kindly request a 10 day payment extension. Please confirm if this is possible.
Best Regards, ChatAI Bot”

“

At the third step S1103, this prompt is passed to the LLM module 407a which generates an appropriate output. For example, SQL code:
“UPDATE Invoices SET invoice_due_date=DATE_ADD (invoice_due_date, INTERVAL 10 DAY) WHERE invoice_number=‘1321341’ AND invoice_issuer=‘Amazon’;”

As will be understood, This SQL query identifies the specific record by “invoice_number” and “invoice_issuer” and updates the “invoice_due_date” by adding 10 days.

At the fourth step S1104, this output is passed to the database 409a, and at the fifth step S1105, a corresponding update is made to the database. Specifically, the “invoice_due_date” for the record with “invoice_number” ‘1321341’ and “invoice_issuer” ‘Amazon’ is extended by 10 days, moving it to Feb. 9, 2023, based on the user's original request.

In the example described above, the database update module 1102a is configured to generate a database update instruction for a SQL database. However, the skilled person will understand that database update instructions can be generated using the same technique for other types of databases. For example, in the case of a NoSQL database, the database update module 1102a could be configured to generate a JSON query, comprising a key and value, to perform the database update. By providing the appropriate prompt to the LLM, the database update module 1102a can generate suitable update instructions dependent, for example, on whether the database is SQL or NoSQL or any other type of database system.

As will be understood, the systems 401a and 1101a depicted in FIGS. 4 and 10 respectively can be implemented in any suitable way. FIG. 9 provides simplified schematic diagram of such an example of such an implementation. FIG. 9 shows a user device 901a connected via a network 902a to an application server 903a. FIG. 9 also shows a database 904a connected to the application server via the network 902a.

The user device 901a provided by any suitable computing device such as desktop computer, laptop, tablet, or smartphone, has running thereon a web browser providing a client application via which the user interface 402a is implemented. The application server 903a has running thereon software implementing the user data processing module 403a, vector generation module 404a, vector comparison module 405a, prompt generation module 406a, LLM module 407a, output review module 408a, and, in the example embodiments described with reference to FIG. 10, the database update module 1102a. This software can be in the form of a web server application configured to communicate data to and from the client application running on the user device 901a. The database 904a corresponds to the database 409a described above.

The skilled person will understand that the prompt-template generating LLM module 407a is an abstraction representing complex data processing functionalities for implementing Large Language Models. These include data processing functionalities for receiving human-readable prompts and converting them through tokenisation into a numerical format suitable for a neural network. These further include data processing functionalities for passing the input through a network's layers, involving, for example, various mechanisms like attention and activation functions, based on the specific architectural configuration. These further include data processing functionalities for interpreting the output and decoding it back into a human-readable form, including components for preprocessing and postprocessing.

The LLM module 407a can be implemented using conventional, generally trained LLMs or may be specifically trained to generate the output in question.

The skilled person will understand that the term ‘LLM’ refers broadly to the class of generative AI systems capable of processing and generating text in a manner that resembles human language output. While these systems often employ machine learning techniques, specifically neural networks, the term ‘LLM’ does not restrict them to any particular methodology for understanding context or generating responses. LLMs may exhibit a range of architectures and sizes, and can be trained using various methods. The scope of ‘LLM’ is intended to encompass all generative systems that can achieve these functions, without limiting them to any specific architecture, model, or training approach.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer implemented method of detecting hallucination in a large language model (LLM) output, said method comprising the steps of:
receiving a message;
generating a prompt for an LLM including the message and an instruction to generate an output identifying predetermined content in the message;
passing the prompt through an LLM to generate the output;
processing the output in accordance with a hallucination detection process to identify if any predetermined content identified by the LLM in the output is potentially hallucinated.

2. A computer implemented method according to claim 1, further comprising:
generating an output indicative of whether the hallucination detection process has identified that the predetermined content identified in the output is potentially hallucinated.

3. A computer implemented method according to claim 1, processing the output in accordance with the hallucination detection process comprises:
performing a content search operation of the received message to identify in the received message the predetermined content identified in the output of the LLM, and, if the predetermined content identified in the output of the LLM is not identified in the received message,
identifying the output of the LLM as potentially hallucinated.

4. A computer implemented method according to claim 1, processing the output in accordance with the hallucination detection process comprises:
receiving from an LLM API confidence score data associated with the output generated by the LLM;
determining if a confidence score associated with the confidence score data exceeds a predetermined confidence threshold, and, if the confidence score does not exceed the predetermined threshold,
identifying the output of the LLM as potentially hallucinated.

5. A computer implemented method according to claim 1, wherein the predetermined content comprises predetermined business process metadata.

6. A computer implemented method according to claim 5, wherein the predetermined business process metadata comprises predetermined financial transaction metadata.

7. A computer implemented method according to claim 1, wherein the message is an email.

8. A computer implemented method according to claim 7, wherein generating the prompt for the LLM comprises generating a prompt including unstructured text data from the body and/or header of the email and the instruction to generate the output identifying predetermined content in the text data of the message.

9. A computer system for detecting hallucination in a large language model (LLM) output, said system comprising a message receiving module communicatively connected to a prompt generation module, said message receiving module configured to receive a message and pass the message to the prompt generation module, said prompt generation module configured to generate a prompt for an LLM including the message and an instruction to generate an output identifying predetermined content in the message, said prompt generation module configured to communicate the generated prompt to an LLM API, said LMM API configured to pass the prompt through an LLM to generate the output, wherein
the system further comprises a hallucination detection module, said hallucination detection module configured to receive the output of the LLM from the LLM API and process the output in accordance with a hallucination detection process to identify if any predetermined content identified by the LLM in the output is potentially hallucinated.

10. A computer system according to claim 9, wherein the hallucination detection module is further configured to generate an output indicative of whether the hallucination detection process has identified that the predetermined content identified in the output is potentially hallucinated.

11. A computer system according to claim 9, wherein the hallucination detection module is configured to perform the hallucination detection process by performing a content search operation of the received message to identify in the received message the predetermined content identified in the output of the LLM, and, if the predetermined content identified in the output of the LLM is not identified in the received message, identifying the output of the LLM as potentially hallucinated.

12. A computer system according to claim 9, wherein the hallucination detection module is configured to perform the hallucination detection process by
receiving from the LLM API confidence score data associated with the output generated by the LLM;
determining if a confidence score associated with the confidence score data exceeds a predetermined confidence threshold, and, if the confidence score does not exceed the predetermined threshold,
identifying the output of the LLM as potentially hallucinated.

13. A computer system according to claim 9, wherein the predetermined content comprises predetermined business process metadata.

14. A computer system according to claim 13, wherein the predetermined business process metadata comprises predetermined financial transaction metadata.

15. A computer system according to claim 9, wherein the message is an email.

16. A computer system according to claim 15, wherein the prompt generation module is configured to generate the prompt for the LLM by generating a prompt including:
unstructured text data from the body and/or header of the email, and
the instruction to generate the output identifying predetermined content in the text data of the message

17. A computer program which when executed on a computing device controls the computing device to implement a method according to claim 1.
